(19) United States
(12) Patent Application Publication
(10) Pub. No.: US 2025/0209583 A1
(43) Pub. Date: Jun. 26, 2025

(54) IMAGE QUALITY ASSESSMENT BASED ON FLEXIBLE REFERENCE

(71) Applicant: City University of Hong Kong, Kowloon (HK)

(72) Inventors: Sam Tak Wu Kwong, Kowloon (HK); Shiqi Wang, Kowloon (HK); Yu Tian, Kowloon (HK); Baoliang Chen, Kowloon (HK)

(21) Appl. No.: 18/395,527

(22) Filed: Dec. 23, 2023

(51) Int. Cl. G06T 7/00; G06V 10/40; G06V 10/77; G06V 10/776; G06V 10/82

(52) U.S. Cl. CPC G06T 7/0002; G06V 10/40; G06V 10/7715; G06V 10/776; G06V 10/82; G06T 2207/20081; G06T 2207/20084; G06T 2207/30168

(57) ABSTRACT

A novel FR-IQA paradigm involving a flexible reference selection is proposed. It dedicates to generating the reference feature by finding the best explanation of the distorted feature among an equal-quality space constructed based on a given pristine feature. Without the ground-truth reference for distorted images with various distortion types, the quality regression loss, the disturbance maximization loss and the content loss are employed to optimize the pseudo-reference feature learning. Experimental results on five IQA benchmark databases demonstrate that combining the FLRE with the existing deep feature-based FR-IQA models can gain performance improvement.

### FIELD OF INVENTION

This invention relates to digital image quality assessment, and in particular to quality assessment of a distorted image as compared to a pristine image.

### BACKGROUND OF INVENTION

Objective image quality assessment (IQA), which aims to automatically quantify the extent of the distortions corrupting the images, provides the quality monitoring criteria or optimization goal in numerous vision-centric systems [1], [2], [3], [4], [5], [6], [7], [8]. Generally speaking, according to the availability of the reference images, existing IQA methods fall into three categories: full-reference IQA (FR-IQA) [9], [10], [11], reduced-reference IQA (RR-IQA) [12], [13], [14], and no-reference IQA (NR-IQA) [15], [16], [17], [18], [19], [20], [21], [22].

Existing FR-IQA methods can be historically divided into two categories according to top-down and bottom-up design philosophies, where the former attempts to model the overall functionalities of human visual system (HVS) with certain hypotheses, and the latter aims to simulate the processing stages in the visual pathway of the HVS. One mild assumption in FR-IQA is that the distorted image is generated from the reference image which is of pristine quality, such that the perceptual fidelity or similarity can be quantified. Therefore, it is natural to treat the given pristine-quality image as the reference in producing a quantitative score that quantifies the degree of fidelity/similarity.

### REFERENCES

The following references are referred to throughout this specification, as indicated by the numbered brackets:
[1]L.-H. Chen, C. G. Bampis, Z. Li, A. Norkin, and A. C. Bovik, “Proxiqa: A proxy approach to perceptual optimization of learned image compression,” IEEE Trans. Image Process, vol. 30, pp. 360-373, 2021.
[2]Q. Xu, J. Xiong, X. Cao, and Y. Yao, “Parsimonious mixed-effects hodgerank for crowdsourced preference aggregation,” in Proc. ACM Int. Conf. Multimedia, 2016, pp. 841-850.
[3]Y. Zhang, L. Zhu, G. Jiang, S. Kwong, and C.-C. J. Kuo, “A survey on perceptually optimized video coding,” ACM Comput. Surv., vol. 55, no. 12, pp. 1-37, 2023.
[4]G. Zhai and X. Min, “Perceptual image quality assessment: a survey,” Sci. China Inf. Sci., vol. 63, pp. 1-52, 2020.
[5] X. Min, K. Gu, G. Zhai, X. Yang, W. Zhang, P. Le Callet, and C. W. Chen, “Screen content quality assessment: overview, benchmark, and beyond,” ACM Comput. Surv., vol. 54, no. 9, pp. 1-36, 2021.
[6]Q. Xu, J. Xiong, Q. Huang, and Y. Yao, “Online hodgerank on random graphs for crowdsourceable qoe evaluation,” IEEE Trans. Multimedia, vol. 16, no. 2, pp. 373-386, 2014.
[7]Q. Xu, Q. Huang, T. Jiang, B. Yan, W. Lin, and Y. Yao, “Hodgerank on random graphs for subjective video quality assessment,” IEEE Trans. Multimedia, vol. 14, no. 3, pp. 844-857, 2012.
[8]Q. Xu, T. Jiang, Y. Yao, Q. Huang, B. Yan, and W. Lin, “Random partial paired comparison for subjective video quality assessment via hodgerank,” in Proc. ACM Int. Conf. Multimedia, no. 10, 2011, pp. 393-402.
[9]Z. Wang, A. C. Bovik, H. R. Sheikh, and E. P. Simoncelli, “Image quality assessment: from error visibility to structural similarity,” IEEE Trans. Image Process., vol. 13, no. 4, pp. 600-612, 2004.
[10] X. Min, G. Zhai, K. Gu, X. Yang, and X. Guan, “Objective quality evaluation of dehazed images,” IEEE Trans. Intell. Transp. Syst., vol. 20, no. 8, pp. 2879-2892, 2019.
[11] X. Liu, Y. Zhang, S. Hu, S. Kwong, C.-C. J. Kuo, and Q. Peng, “Subjective and objective video quality assessment of 3d synthesized views with texture/depth compression distortion,” IEEE Trans. Image Process., vol. 24, no. 12, pp. 4847-4861, 2015.
[12]A. Rehman and Z. Wang, “Reduced-reference image quality assessment by structure similarity estimation,” IEEE Trans. Image Process., vol. 21, no. 8, pp. 3378-3389, 2012.
[13]S. Golestaneh and L. J. Karam, “Reduced-reference quality assessment based on the entropy of dwt coefficients of locally weighted gradient magnitudes,” IEEE Trans. Image Process., vol. 25, no. 11, pp. 5293-5303, 2016.
[14]J. Wu, W. Lin, G. Shi, L. Li, and Y. Fang, “Orientation selectivity based visual pattern for reduced-reference image quality assessment,” Inf. Sci., vol. 351, pp. 18-29, 2016.
[15]Z. Pan, F. Yuan, J. Lei, Y. Fang, X. Shao, and S. Kwong, “Vcrnet: Visual compensation restoration network for no-reference image quality assessment,” IEEE Trans. Image Process., vol. 31, pp. 1613-1627, 2022.
[16] X. Liu, J. van de Weijer, and A. D. Bagdanov, “Rankiqa: Learning from rankings for no-reference image quality assessment,” in Proc. Int. Conf. Comput. Vis., 2017.
[17]B. Chen, H. Li, H. Fan, and S. Wang, “No-reference screen content image quality assessment with unsupervised domain adaptation,” IEEE Trans. Image Process, vol. 30, pp. 5463-5476, 2021.
[18] X. Wang, J. Xiong, and W. Lin, “Visual interaction perceptual network for blind image quality assessment,” IEEE Trans. Multimedia, pp. 1-13, 2023.
[19]L. Shen, B. Zhao, Z. Pan, B. Peng, S. Kwong, and J. Lei, “Channel recombination and projection network for blind image quality measurement,” IEEE Trans. Instrum. Meas., vol. 71, pp. 1-12, 2022.
[20]Z. Pan, H. Zhang, J. Lei, Y. Fang, X. Shao, N. Ling, and S. Kwong, “Dacnn: Blind image quality assessment via a distortion-aware convolutional neural network,” IEEE Trans. Circuits Syst. Video Technol., vol. 32, no. 11, pp. 7518-7531, 2022.
[21]Z. Pan, F. Yuan, X. Wang, L. Xu, X. Shao, and S. Kwong, “No-reference image quality assessment via multibranch convolutional neural networks,” IEEE Trans. Artif Intell., vol. 4, no. 1, pp. 148-160, 2023.
[22] X. Min, K. Ma, K. Gu, G. Zhai, Z. Wang, and W. Lin, “Unified blind quality assessment of compressed natural, graphic, and screen content images,” IEEE Trans. Image Process, vol. 26, no. 11, pp. 5462-5474, 2017.
[23]L. Jin, J. Y. Lin, S. Hu, H. Wang, P. Wang, I. Katsavounidis, A. Aaron, and C.-C. J. Kuo, “Statistical study on perceived jpeg image quality via mcl-jci dataset construction and analysis,” Electron. Imag., vol. 2016, no. 13, pp. 1-9, 2016.
[24]D. M. Chandler and S. S. Hemami, “Effects of natural images on the detectability of simple and compound wavelet subband quantization distortions,” J. Opt. Soc. Am. A, vol. 20, no. 7, pp. 1164-1180, 2003.
[25]W. Lin and G. Ghinea, “Progress and opportunities in modelling just-noticeable difference (jnd) for multimedia,” IEEE Trans. Multimedia, vol. 24, pp. 3706-3721, 2021.
[26]Q. Jiang, Z. Liu, S. Wang, F. Shao, and W. Lin, “Toward top-down just noticeable difference estimation of natural images,” IEEE Trans. Image Process., vol. 31, pp. 3697-3712, 2022.
[27] X. Min, G. Zhai, J. Zhou, M. C. Q. Farias, and A. C. Bovik, “Study of subjective and objective quality assessment of audio-visual signals,” IEEE Trans. Image Process, vol. 29, pp. 6054-6068, 2020.
[28]Q. Xu, J. Xiong, Q. Huang, and Y. Yao, “Robust evaluation for quality of experience in crowdsourcing,” in Proc. ACM Int. Conf. Multimedia, 2013, pp. 43-52.
[29]Q. Xu, Q. Huang, and Y. Yao, “Online crowdsourcing subjective image quality assessment,” in Proc. ACM Int. Conf. Multimedia, 2012, pp. 359-368.
[30]K. Ding, K. Ma, S. Wang, and E. P. Simoncelli, “Comparison of full-reference image quality models for optimization of image processing systems,” Int. J. Comput. Vis., vol. 129, pp. 1258-1281, 2021.
[31]J. G. Robson, “Spatial and temporal contrast-sensitivity functions of the visual system,” Josa, vol. 56, no. 8, pp. 1141-1142, 1966.
[32] Weber's Law of Just Noticeable Difference, 2017. [Online]. Available: http://apps.usd.edu/coglab/WebersLaw.html
[33]G. E. Legge and J. M. Foley, “Contrast masking in human vision,” Josa, vol. 70, no. 12, pp. 1458-1471, 1980.
[34]S. J. Daly, “Visible differences predictor: an algorithm for the assessment of image fidelity,” Human Vis., Visual Process., Digital Display III, vol. 1666, pp. 2-15, 1992.
[35]P. C. Teo and D. J. Heeger, “Perceptual image distortion,” in Proc. Int. Conf. Image Process., vol. 2, 1994, pp. 982-986.
[36]A. B. Watson, G. Y. Yang, J. A. Solomon, and J. Villasenor, “Visibility of wavelet quantization noise,” IEEE Trans. Image Process., vol. 6, no. 8, pp. 1164-1175, 1997.
[37]V. Laparra, J. Balle', A. Berardino, and E. P. Simoncelii, “Perceptual image quality assessment using a normalized laplacian pyramid,” Human Vis. Electron. Imag., pp. 43-48, 2016.
[38]L. Zhang, L. Zhang, X. Mou, and D. Zhang, “Fsim: A feature similarity index for image quality assessment,” IEEE Trans. Image Process., vol. 20, no. 8, pp. 2378-2386, 2011.
[39]W. Xue, L. Zhang, X. Mou, and A. C. Bovik, “Gradient magnitude similarity deviation: A highly efficient perceptual image quality index,” IEEE Trans. Image Process, vol. 23, no. 2, pp. 684-695, 2013.
[40]H. R. Sheikh and A. C. Bovik, “Image information and visual quality,” IEEE Trans. Image Process., vol. 15, no. 2, pp. 430-444, 2006.
[41]S. Bosse, D. Maniry, K.-R. Mu'ller, T. Wiegand, and W. Samek, “Deep neural networks for no-reference and full-reference image quality assessment,” IEEE Trans. Image Process., vol. 27, no. 1, pp. 206-219, 2017.
[42]E. Prashnani, H. Cai, Y. Mostofi, and P. Sen, “Pieapp: Perceptual image-error assessment through pairwise preference,” in Proc. IEEE Conf Comput. Vis. Pattern Recog., 2018, pp. 1808-1817.
[43]R. Zhang, P. Isola, A. A. Efros, E. Shechtman, and O. Wang, “The unreasonable effectiveness of deep features as a perceptual metric,” in Proc. IEEE Conf. Comput. Vis. Pattern Recog., 2018, pp. 586-595.
[44]K. Ding, K. Ma, S. Wang, and E. P. Simoncelli, “Image quality assessment: Unifying structure and texture similarity,” IEEE Trans. Pattern Anal. Mach. Intell., vol. 44, no. 5, pp. 2567-2581, 2022.
[45] X. Liao, B. Chen, H. Zhu, S. Wang, M. Zhou, and S. Kwong, “Deepwsd: Projecting degradations in perceptual space to wasserstein distance in deep feature space,” in Proc. ACM Int. Conf. Multimedia, 2022, pp. 970-978.
[46]M. Zhou, X. Wei, S. Kwong, W. Jia, and B. Fang, “Just noticeable distortion-based perceptual rate control in hevc,” IEEE Trans. Image Process., vol. 29, pp. 7603-7614, 2020.
[47]C.-H. Chou and Y.-C. Li, “A perceptually tuned subband image coder based on the measure of just-noticeable-distortion profile,” IEEE Trans. Circuits Syst. Video Technol., vol. 5, no. 6, pp. 467-476, 1995.
[48] X. Zhang, W. Lin, and P. Xue, “Just-noticeable difference estimation with pixels in images,” J. Vis. Commun. Image Represent., vol. 19, no. 1, pp. 30-41, 2008.
[49]A. Liu, W. Lin, M. Paul, C. Deng, and F. Zhang, “Just noticeable difference for images with decomposition model for separating edge and textured regions,” IEEE Trans. Circuits Syst. Video Technol., vol. 20, no. 11, pp. 1648-1652, 2010.
[50]J. Wu, G. Shi, W. Lin, A. Liu, and F. Qi, “Just noticeable difference estimation for images with free-energy principle,” IEEE Trans. Multimedia, vol. 15, no. 7, pp. 1705-1710, 2013.
[51]J. Wu, L. Li, W. Dong, G. Shi, W. Lin, and C.-C. J. Kuo, “Enhanced just noticeable difference model for images with pattern complexity,” IEEE Trans. Image Process, vol. 26, no. 6, pp. 2682-2693, 2017.
[52]Z. Wei and K. N. Ngan, “Spatio-temporal just noticeable distortion profile for grey scale image/video in dct domain,” IEEE Trans. Circuits Syst. Video Technol., vol. 19, no. 3, pp. 337-346, 2009.
[53]L. Ma, K. N. Ngan, F. Zhang, and S. Li, “Adaptive block-size trans-form based just-noticeable difference model for images/videos,” Signal Process. Image Commun., vol. 26, no. 3, pp. 162-174, 2011.
[54]S.-H. Bae and M. Kim, “A novel generalized dct-based jnd profile based on an elaborate cm-jnd model for variable block-sized transforms in monochrome images,” IEEE Trans. Image Process., vol. 23, no. 8, pp. 3227-3240, 2014.
[55] X. Shen, Z. Ni, W. Yang, X. Zhang, S. Wang, and S. Kwong, “Just noticeable distortion profile inference: A patch-level structural visibility learning approach,” IEEE Trans. Image Process., vol. 30, pp. 26-38, 2020.
[56]H. Lin, G. Chen, M. Jenadeleh, V. Hosu, U.-D. Reips, R. Hamzaoui, and D. Saupe, “Large-scale crowdsourced subjective assessment of picturewise just noticeable difference,” IEEE Trans. Circuits Syst. Video Technol., vol. 32, no. 9, pp. 5859-5873, 2022.
[57] X. Min, K. Gu, G. Zhai, J. Liu, X. Yang, and C. W. Chen, “Blind quality assessment based on pseudo-reference image,” IEEE Trans. Multimedia, vol. 20, no. 8, pp. 2049-2062, 2018.
[58] X. Min, G. Zhai, K. Gu, Y. Liu, and X. Yang, “Blind image quality estimation via distortion aggravation,” IEEE Trans. Image Process., vol. 64, no. 2, pp. 508-517, 2018.
[59]J. Ma, J. Wu, L. Li, W. Dong, X. Xie, G. Shi, and W. Lin, “Blind image quality assessment with active inference,” IEEE Trans. Image Process., vol. 30, pp. 3650-3663, 2021.
[60]B. Chen, L. Zhu, C. Kong, H. Zhu, S. Wang, and Z. Li, “No-reference image quality assessment by hallucinating pristine features,” IEEE Trans. Image Process., vol. 31, pp. 6139-6151, 2022.
[61]K. Simonyan and A. Zisserman, “Very deep convolutional networks for large-scale image recognition,” in Proc. Int. Conf. Learn. Represent., 2015, pp. 1-14.
[62]A. Krizhevsky, I. Sutskever, and G. E. Hinton, “Imagenet classification with deep convolutional neural networks,” Commun. ACM, vol. 60, no. 6, pp. 84-90, 2017.
[63]N. J. Priebe and D. Ferster, “Inhibition, spike threshold, and stimulus selectivity in primary visual cortex,” Neuron, vol. 57, no. 4, pp. 482-497, 2008.
[64]K. D. Harris and T. D. Mrsic-Flogel, “Cortical connectivity and sensory coding,” Nature, vol. 503, no. 7474, pp. 51-58, 2013.
[65]T. Park, M.-Y. Liu, T.-C. Wang, and J.-Y. Zhu, “Semantic image synthesis with spatially-adaptive normalization,” in Proc. IEEE Conf. Comput. Vis. Pattern Recog., 2019, pp. 2337-2346.
[66]Y. Shi, X. Liu, Y. Wei, Z. Wu, and W. Zuo, “Retrieval-based spatially adaptive normalization for semantic image synthesis,” in Proc. IEEE Conf. Comput. Vis. Pattern Recog., 2022, pp. 11 224-11 233.
[67]D. Ulyanov, A. Vedaldi, and V. Lempitsky, “Instance normalization: The missing ingredient for fast stylization,” arXiv preprint arXiv:1607.08022, 2016.
[68]D. C. Knill and A. Pouget, “The bayesian brain: the role of uncertainty in neural coding and computation,” Trends Neurosci., vol. 27, no. 12, pp. 712-719, 2004.
[69]K. Friston, J. Kilner, and L. Harrison, “A free energy principle for the brain,” J. Physiol., vol. 100, no. 1-3, pp. 70-87, 2006.
[70]G. Zhai, X. Min, and N. Liu, “Free-energy principle inspired visual quality assessment: An overview,” Digital Signal Process., vol. 91, pp. 11-20, 2019.
[71]K. Gu, G. Zhai, X. Yang, and W. Zhang, “Using free energy principle for blind image quality assessment,” IEEE Trans. Multimedia, vol. 17, no. 1, pp. 50-63, 2015.
[72]G. Zhai, Y. Zhu, and X. Min, “Comparative perceptual assessment of visual signals using free energy features,” IEEE Trans. Multimedia, vol. 23, pp. 3700-3713, 2021.
[73]H. Lin, V. Hosu, and D. Saupe, “Kadid-10k: A large-scale artificially distorted iqa database,” in Proc. Int. Conf. Quality Multimedia Exper., 2019, pp. 1-3.
[74]H. R. Sheikh, M. F. Sabir, and A. C. Bovik, “A statistical evaluation of recent full reference image quality assessment algorithms,” IEEE Trans. Image Process., vol. 15, no. 11, pp. 3440-3451, 2006.
[75]N. Ponomarenko, L. Jin, O. Ieremeiev, V. Lukin, K. Egiazarian, J. Astola, B. Vozel, K. Chehdi, M. Carli, F. Battisti et al., “Image database tid2013: Peculiarities, results and perspectives,” Signal Process., Image Commun., vol. 30, pp. 57-77, 2015.
[76]E. C. Larson and D. M. Chandler, “Most apparent distortion: full-reference image quality assessment and the role of strategy,” J. Electron. Imag., vol. 19, no. 1, pp. 011 006-011 006, 2010.
[77]F. Zhou, R. Yao, B. Liu, and G. Qiu, “Visual quality assessment for super-resolved images: Database and method,” IEEE Trans. Image Process., vol. 28, no. 7, pp. 3528-3541, 2019.
[78] X. Min, G. Zhai, K. Gu, Y. Zhu, J. Zhou, G. Guo, X. Yang, X. Guan and W. Zhang, “Quality evaluation of image dehazing methods using synthetic hazy images,” IEEE Trans. Multimedia, vol. 21, no. 9, pp. 2319-2333, 2019.
[79]G. Jinjin, C. Haoming, C. Haoyu, Y. Xiaoxing, J. S. Ren, and D. Chao, “Pipal: a large-scale image quality assessment dataset for perceptual image restoration,” in Proc. Eur. Conf. Comput. Vis., 2020, pp. 633-651.
[80]L. A. Gatys, A. S. Ecker, and M. Bethge, “Image style transfer using convolutional neural networks,” in Proc. IEEE Conf. Comput. Vis. Pattern Recog., 2016, pp. 2414-2423.
[81]Y. Jing, Y. Yang, Z. Feng, J. Ye, Y. Yu, and M. Song, “Neural style transfer: A review,” IEEE Trans. Vis. Comput. Graph., vol. 26, no. 11, pp. 3365-3385, 2019.
[82]Z. Wang, E. P. Simoncelli, and A. C. Bovik, “Multiscale structural similarity for image quality assessment,” in Proc. IEEE Asilomar Conf. Signals, Syst. Comput., vol. 2, 2003, pp. 1398-1402.
[83]L. Zhang, Y. Shen, and H. Li, “Vsi: A visual saliency-induced index for perceptual image quality assessment,” IEEE Trans. Image Process., vol. 23, no. 10, pp. 4270-4281, 2014.
[84]V. Laparra, A. B. J. Balle, and E. P. Simoncelli, “Perceptual image quality assessment using a normalized laplacian pyramid,” Electron. Imag., vol. 2016, no. 16, pp. 43-48, 2016.
[85]A. Paszke, S. Gross, F. Massa, A. Lerer, J. Bradbury, G. Chanan, T. Killeen, and Z. L. et al., “Pytorch: An imperative style, high-performance deep learning library,” Adv. Neural Inform. Process. Syst., vol. 32, pp. 8026-8037, 2019.
[86]D. P. Kingma and J. Ba, “Adam: a method for stochastic optimization,” in Proc. Int. Conf. Learn. Represent., 2015.
[87]V. Q. E. Group, “Final report from the video quality experts group on the validation of objective models of video quality assessment,” VQEG meeting, 2020.
[88]B. Bross, J. Chen, J.-R. Ohm, G. J. Sullivan, and Y.-K. Wang, “Developments in international video coding standardization after avc, with an overview of versatile video coding (vvc),” IEEE, vol. 109, no. 9, pp. 1463-1493, 2021.

### SUMMARY OF INVENTION

The invention in one aspect provides an image quality assessment IQA method, which includes the steps of providing a pristine image as well as a distorted image related to the pristine image, constructing an equal-quality space of the pristine image at feature level, finding, within the equal-quality space, a best reference of a distorted feature of the distorted image, and constructing a pseudo-reference feature of the distorted feature.

In some embodiments, the step of constructing an equal-quality space of the pristine image further includes estimating a near-threshold map of a feature extracted from the pristine image, and constructing the equal-quality space under a guidance of the near-threshold map.

In some embodiments, the step of estimating a near-threshold map of a feature extracted from the pristine image, further includes predicting the near-threshold map based on a global spatial correlation map and a local spatial correlation map.

In some embodiments, the method further includes, before the step of predicting the near-threshold map, the steps of calculating a global standard deviation of the feature extracted from the pristine image, calculating a local standard deviation of the feature extracted from the pristine image; and generating the global and local spatial correlation maps based on the global and local standard deviations.

In some embodiments, the step of finding the best reference of the distorted feature further includes locating the best reference of the distorted feature within the equal-quality space in an element-wise minimum distance search manner.

In some embodiments, the method further contains a step of optimizing the constructed equal-quality space using at least one of a quality regression loss, a disturbance maximization loss and a content loss.

In some embodiments, the step of optimizing the constructed equal-quality space uses all of the quality regression loss, the disturbance maximization loss and the content loss.

In some embodiments, in the step of constructing an equal-quality space of the pristine image, the equal-quality space is constructed using a pre-trained artificial neural network.

In some embodiments, the step of finding the best reference of the distorted feature is performed at every layer of the artificial neural network.

In some embodiments, the method further includes a step of predicting a quality score based on the distorted feature and the pseudo-reference feature.

According to another aspect of the invention, there is provided a non-transitory computer-readable memory recording medium having computer instructions recorded thereon, the computer instructions, when executed on one or more processors, causing the one or more processors to perform operations according to the image quality assessment IQA method as mentioned above.

According to a further aspect of the invention, there is provided a computing system that includes one or more processors, and an memory containing instructions that, when executed by the one or more processors, cause the computing system to perform operations according to the image quality assessment IQA method as mentioned above.

Embodiments of the invention therefore provide FR-IQA methods involving a flexible reference selection. Such methods dedicate to generating the reference feature by finding the best explanation of the distorted feature among an equal-quality space constructed based on a given pristine feature. Even without the ground-truth reference for distorted images with various distortion types, the pseudo-reference feature learning can be optimized.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 illustrates a FLRE paradigm according to first embodiment of the invention, as well as its working principle.

FIG. 2 shows an exemplary equal-quality space constructed by the FLRE of FIG. 1.

FIG. 3a shows the given pristine-quality image in the equal-quality space of FIG. 2 separately.

FIG. 3b shows an equal-quality image to the image in FIG. 3a, which is sampled from the MCL JCL dataset [23].

FIG. 3c is a difference map between the images in FIG. 3a and FIG. 3b.

FIG. 4 shows a comparison between a traditional FR-IQA and the FLRE of FIG. 1.

FIG. 5 shows a detailed structure of the PNTE module in the FLRE of FIG. 1.

FIG. 6 is an illustration of the PRS strategy in the FLRE of FIG. 1.

FIG. 7 shows a table that depicts performance comparison on three traditional IQA databases.

FIG. 8 shows a table that depicts performance comparison on three image restoration databases.

FIG. 9 depicts visualization of regression results of different FR-IQA models on TID2013 and PIPAL datasets.

FIG. 10 depicts visualization of the given reference features and the pseudo-reference features generated by FLRE+LPIPS.

### DETAILED DESCRIPTION

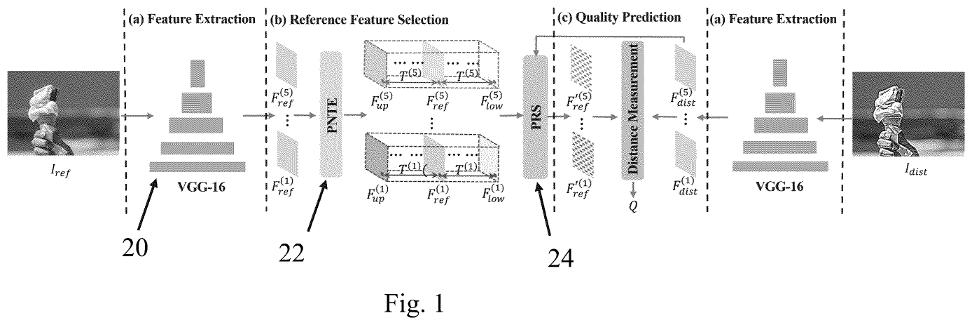

FIG. 1 shows a first embodiment of the invention, which is a FR-IQA paradigm that is designated as FLRE herein. The function of the FLRE is to generate the feature-level reference of a distorted image via the selection of its corresponding best explanation within an equal-quality space for quality assessment. Conventional FR-IQA methods predict the perceptual quality of a distorted image with a given pristine-quality image as the reference. However, the near-threshold visual perception suggests that there could be numerous pristine-quality representations that are indistinguishable in a scene, and the so-called pristine image used in FR-IQA for reference is just one of them. With numerous approaches proposed for FR-IQA by evaluating the perceptual similarity, much less work has been dedicated to locating the best reference for the deterministic perceptual similarity measure. For example, both bottom-up and top-down conventional FR-IQA methods directly apply the given reference image in quantifying the perceptual similarities, but ignore whether the reference image is the best in the sense of perceptual similarity comparisons.

In contrast, the FLRE paradigm in the first embodiment is developed in the feature space by attempting to obtain the feature-level reference of the distorted image via the selection of its corresponding best explanation within an equal-quality space, enabling the freedom in reference image selection for distorted images. To this end, the FLRE in FIG. 1 includes a pre-trained VGG16 network 20, a Perceptually Near-Threshold Estimation (PNTE) module 22 connected to the VGG16 network 20, and a Pseudo-Reference Search (PRS) module 24 connected to the PNTE module 22. Note that the VGG16 network 20 is also connected to the PRS module 24, and for the sake of easy understanding the same VGG16 network 20 is shown twice in FIG. 1. The VGG16 network 20 is adapted to extract features from an input image, and in the example shown in FIG. 1, both a pristine image I_{ref} and a distorted image I_{dist} are inputted to VGG16 network 20 for feature extraction.

The PNTE module 22 and the PRS module 24 are configured in the FLRE to perform PNTE and PRS strategies, respectively. In particular, the PNTE module predicts the equal-quality map of a given pristine-quality feature, forming an equal-quality space. Subsequently, the PRS strategy is employed to locate the reference of the distorted feature within the equal-quality space in an element-wise minimum distance search manner. Due to the lack of the ground-truth reference (i.e., best explanation) of each distorted image, the pseudo-reference feature learning is optimized under three constraints, i.e., the quality regression loss, the disturbance maximization loss, and the content loss. The FLRE is implemented as a plug-in module before the deterministic FR-IQA process, and experimental results that will be described later have demonstrated that combining FLRE with the existing deep feature-based FR-IQA models can significantly improve the quality prediction performance, largely surpassing the state-of-the-art methods. Details of the working flow of the FLRE are discussed below.

Given the pristine image I_{ref} and the distorted image I_{dist} as shown in FIG. 1, firstly the pre-trained VGG16 network 20 is used to extract their hierarchical representations, i.e., F_{ref} and F_{dist}. Then, the PNTE module 22 is used to predict the near-threshold map of F_{ref}, constructing the equal-quality space. Subsequently, for the distorted feature at each scale, the PRS module 24 follows the element-wise search manner to locate the reference feature of the distorted feature. Finally, the quality score is predicted based on the distorted and its pseudo-reference features.

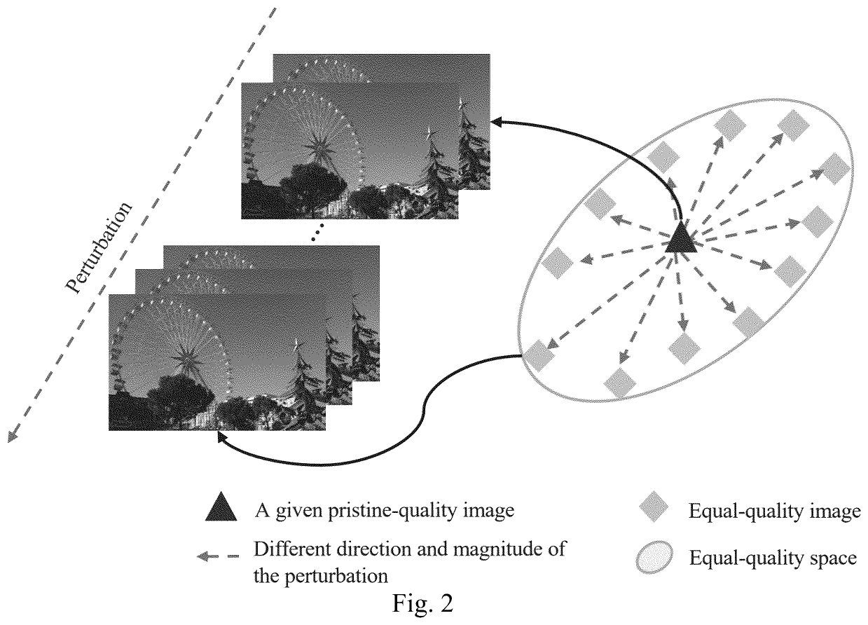

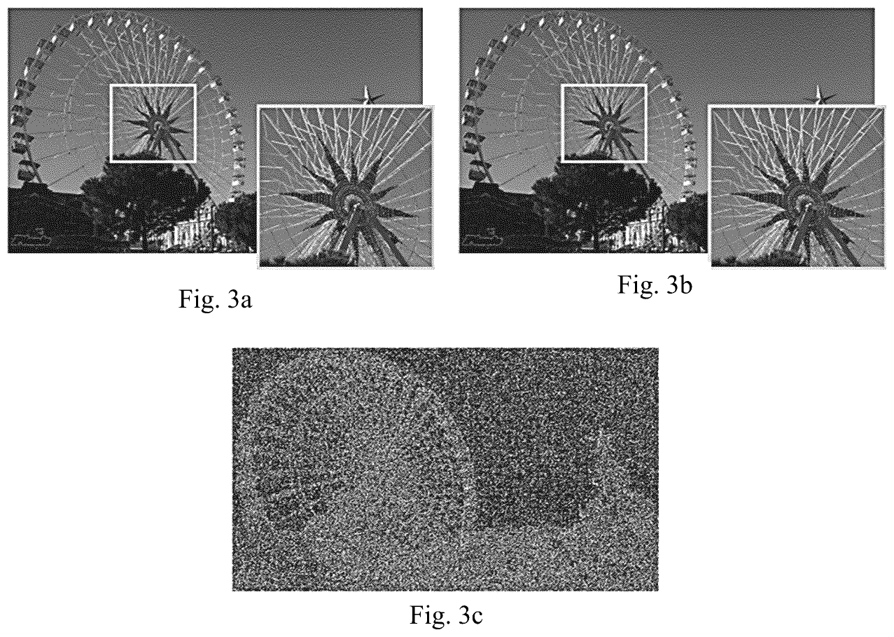

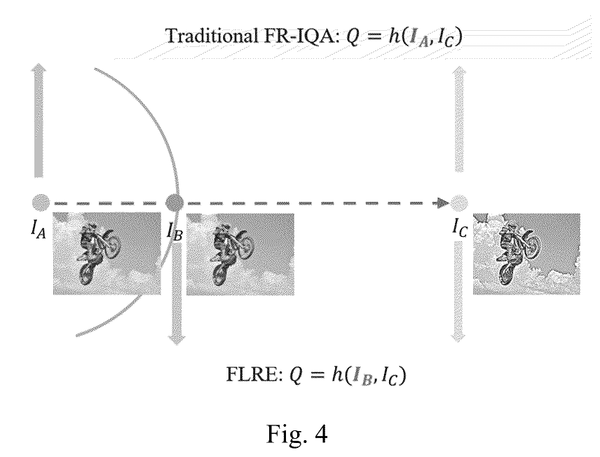

FIG. 2 shows an illustration of an exemplary equal-quality space constructed by the FLRE. When centered on a given pristine-quality image as shown in FIG. 3a, numerous equal-quality images can be generated by perturbing it within the visual perception threshold in various directions and magnitudes, forming the equal-quality space. In the equal-quality space, all images have the same perceptual quality as the given pristine-quality image. While FIG. 3a shows the given pristine-quality image for the equal-quality space of FIG. 2, FIG. 3b is an equal-quality image sampled from the MCL JCL dataset. FIG. 3c shows the difference map between FIG. 3a and FIG. 3b. The PNSR value between FIG. 3a and FIG. 3b is 35.44 dB. FIG. 4 shows a comparison of the traditional FR-IQA and the FLRE. I_{A} and I_{C} are the given pristine-quality image and the distorted image, respectively. h is the perceptual quality measure in a given FR-IQA. For the traditional FR-IQA paradigm, the quality score is directly computed based on I_{A} and I_{C}, i.e., h(I_{A}, I_{C}). For the FLRE, the reference of I_{C} is its best explanation I_{B} within the equal-quality space, such that h(I_{B}, I_{C}) is calculated.

Next, the design process of the FLRE will be described. As mentioned above, the new FR-IQA paradigm in FIG. 1 is developed by attempting to generate the feature-level reference of a distorted image via the selection of its corresponding best explanation within an equal-quality space, such that the quality score of the distorted image is predicted based on the distorted feature and its best explanation.

### A. Equal-Quality Space Construction

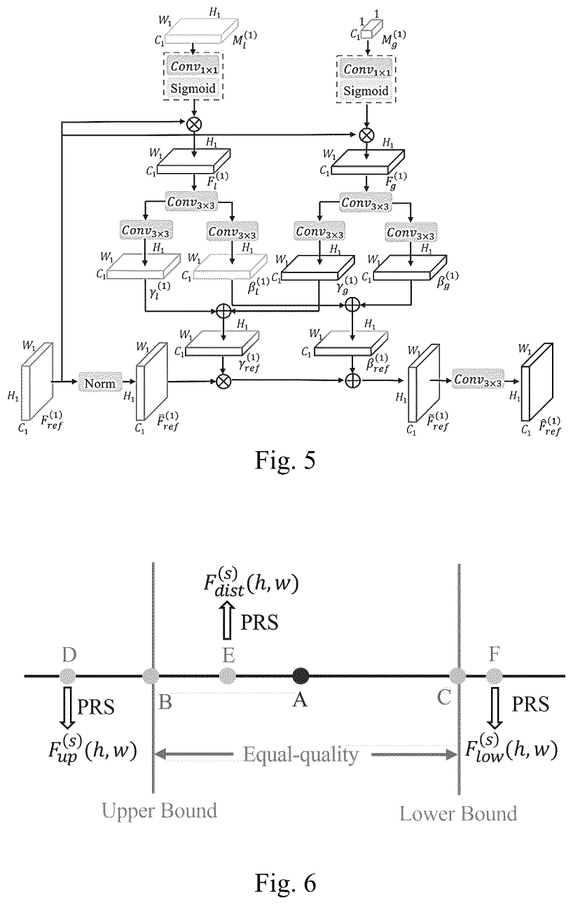

Based on the near-threshold characteristics of the HVS, the PNTE module 22 is devised to estimate the near-threshold map of the feature extracted from a given pristine-quality image, thereby constructing an equal-quality space under the guidance of the near-threshold map. As shown in FIG. 1, firstly the pre-trained VGG16 network 20 [61] is employed on the ImageNet [62] database to extract the feature representations of the given pristine-quality image (denoted as I_{ref}) as follows,

$${F}_{ref} = \{ {F}_{ref}^{( s )} ; s = 1 , … , S \} , \qquad ( 1 )$$

where F_{ref}^{s}∈ [symbol] denotes the feature representation of I_{ref} at the s-th layer of the VGG space. Cₛ and Hₛ×Wₛ represent the channel and spatial dimensions of feature representation at the s-th layer, respectively. S is the total number of layers. In this embodiment, feature representations from conv1_2, conv2_2, conv3_3, conv4_3, and conv5_3 in the VGG16 network 20 are adopted. Visual perception thresholds are determined by interactions or interference among stimuli. Herein, the spatial correlation in the feature map is taken into account. In particular, the global and local standard deviation of F_{ref}⁽¹⁾ are calculated to obtain the global and local spatial correlation maps (denoted as M_{g}⁽¹⁾∈ [symbol] and Mₗ⁽¹⁾∈ [symbol] , respectively), where the size of the sliding window in local standard deviation calculation is 3×3 with a stride of 1. Subsequently, the near-threshold map is predicted with the aid of the global and local spatial correlation maps. As shown in FIG. 5, firstly F_{ref}⁽¹⁾ of is normalized by the instance-normalization layer [67](denoted as Norm) as follows,

$${\overline{F}}_{ref}^{( 1 )} ( c , h , w ) = \frac{{F}_{ref}^{( 1 )} ( c , h , w ) - {μ}_{c}}{{σ}_{c}} , \qquad ( 2 )$$

where μ_{c}, and σ_{c} are computed across spatial dimensions independently for each channel:

$${μ}_{C} = \frac{1}{{H}_{1} {W}_{1}} {\sum }_{w = 1}^{{W}_{1}} {\sum }_{h = 1}^{{H}_{1}} {F}_{ref}^{( 1 )} ( c , h , w ) , \qquad ( 3 )$$

$${σ}_{C} = \sqrt{\frac{1}{{H}_{1} {W}_{1}} {\sum }_{w = 1}^{{W}_{1}} {\sum }_{h = 1}^{{H}_{1}} {( {F}_{ref}^{( 1 )} ( c , h , w ) - {μ}_{C} )}^{2}} . \qquad ( 4 )$$

Then, the local and global spatial correlation maps are fed into two four-layer convolutional networks, respectively, to generate the local perceptual-based modulation parameters (denoted as γₗ⁽¹⁾ for scale and βₗ¹ for bias) and the global perceptual-based modulation parameters (denoted as γ_{g}⁽¹⁾ and β_{g}⁽¹⁾. Two sets of parameters are summed to obtain the final modulation parameters (denoted as γ_{ref}⁽¹⁾ and β_{ref}⁽¹⁾ for F̅_{ref}⁽¹⁾,

$${γ}_{ref}^{( 1 )} = {α}_{γ} {γ}_{l}^{( 1 )} + ( 1 - {α}_{γ} ) {γ}_{g}^{( 1 )} , \qquad ( 5 )$$

$${β}_{ref}^{( 1 )} = {α}_{β} {β}_{l}^{( 1 )} + ( 1 - {α}_{β} ) {β}_{g}^{( 1 )} , \qquad ( 6 )$$

where α_{γ} and α_{β} are learnable weight parameters. The modulated feature \tilde{F}_{ref}⁽¹⁾ can be generated by denormalizing F̅_{ref}⁽¹⁾, according to γ_{ref}⁽¹⁾ and β_{ref}⁽¹⁾,

$${\tilde{F}}_{ref}^{( 1 )} = {γ}_{ref}^{( 1 )} {\overline{F}}_{ref}^{( 1 )} + {β}_{ref}^{( 1 )} . \qquad ( 7 )$$

The modulated feature is fed into a 3×3 convolution with the stride of 1, generating the near-threshold map \hat{F}_{ref}⁽¹⁾ that is just at the critical point of perceptual equivalence. Subsequently, the feature representations are collected from conv2_2, conv3_3, conv4_3, and conv5_3 in the pre-trained VGG16 network 20 when the input of conv2_2 is replaced from F_{ref}⁽¹⁾ of to \hat{F}_{ref}⁽¹⁾. The hierarchical near-threshold feature maps (denoted as \hat{F}_{ref}) can be represented as follows,

$${\hat{F}}_{ref} = \{ {\hat{F}}_{ref}^{( s )} ; s = 1 , … , S \} , \qquad ( 8 )$$

where \hat{F}_{ref}⁽¹⁾∈ [symbol] represents the near-threshold map at s-th layer in the VGG space. S is the total number of the layers. For F_{ref}^{(s)}, its perceptual threshold map (denoted as T^{(s)}∈ [symbol] can be computed as follows,

$${T}^{( s )} = \vert {F}_{ref}^{( s )} - {\hat{F}}_{ref}^{( s )} \vert , \qquad ( 9 )$$

where |⋅| is the absolute value operation. Therefore, numerous equal-quality features can be generated by varying the feature of the given pristine-quality image according to T^{(s)}, constructing the equal-quality space. The equal-quality maps on the bounds of the equal-quality space can be represented as follows,

$${F}_{up}^{( s )} = {F}_{ref}^{( s )} + {T}^{( s )} , \qquad ( 10 )$$

$${F}_{low}^{( s )} = {F}_{ref}^{( s )} - {T}^{( s )} , \qquad ( 11 )$$

where Fᵤₚ^{(s)} is the equal-quality map on the upper bound and F_{low}^{(s)} is the equal-quality map on the lower bound.

### B. Pseudo-Reference Search

Human brain can actively infer the best explanation (i.e., ideal reference) of the distorted image [68], [69], [70], [71], [72]. Based on the hypothesis that the best explanation of the distorted feature is the feature among all equal-quality features with the smallest distance to the distorted feature, the PRS strategy is developed to locate the reference of the distorted feature within the equal-quality space in an element-wise minimum distance search manner. Let F_{dist}^{(s)} be the feature representation of the distorted image I_{dist} at the s-th layer in the VGG space. FIG. 6 shows examples of using the PRS strategy for different F_{dist}^{(s)}(h,w). In FIGS. 6, A, B and C are F_{ref}^{(s)}(h,w), Fᵤₚ^{(s)}(h,w) and F_{low}^{(s)}(h,w), respectively. D, E and F are different examples with respect to F_{dist}^{(s)}(h,w). The PRS strategy is to locate the feature with the smallest distance to F_{dist}^{(s)}(h,w) among all equal-quality features in the equal-quality space via the element-wise manner. More specifically, for F_{dist}^{(s)}(h,w), its reference (denoted as F′_{dist}^{(s)}(h,w)) can be described as

$${F}_{ref}^{′ ( s )} ( h , w ) = \{ \begin{matrix}{F}_{dist}^{( s )} ( h , w ) & if {T}^{( s )} ( h , w ) > {D}_{0}^{( s )} ( h , w ) \\ {F}_{up}^{( s )} ( h , w ) & if {T}^{( s )} ( h , w ) \leq {D}_{0}^{( s )} ( h , w ) \\ & and {D}_{1}^{( s )} ( h , w ) \geq {D}_{2}^{( s )} ( h , w ) \\ {F}_{low}^{( s )} ( h , w ) & if {T}^{( s )} ( h , w ) \leq {D}_{0}^{( s )} ( h , w ) \\ & and {D}_{1}^{( s )} ( h , w ) < {D}_{2}^{( s )} ( h , w ) ,\end{matrix} \qquad ( 12 )$$

where D₀^{s}) (h,w), D₁^{s}) (h,w) and D₂^{s}) (h,w) are the distances from F_{ref}^{(s)}(h,w), F_{low}^{(s)}(h,w) and Fᵤₚ^{(s)}(h,w) to F_{dist}^{(s)}(h,w), respectively. They can be calculated as follows,

$${D}_{0}^{( s )} ( h , w ) = \vert {F}_{ref}^{( s )} ( h , w ) - {F}_{dist}^{( s )} ( h , w ) \vert , \qquad ( 13 )$$

$${D}_{1}^{( s )} ( h , w ) = \vert {F}_{low}^{( s )} ( h , w ) - {F}_{dist}^{( s )} ( h , w ) \vert , \qquad ( 14 )$$

$${D}_{2}^{( s )} ( h , w ) = \vert {F}_{up}^{( s )} ( h , w ) - {F}_{dist}^{( s )} ( h , w ) \vert . \qquad ( 15 )$$

During quality prediction, the quality score Q of the distorted image is computed based on F′_{ref} and F_{dist},

$$Q = f ( {F}_{ref}^{′} , {F}_{dist} ) , \qquad ( 16 )$$

where F′_{ref}={F_{ref}^{(s)}; s=1, . . . , S} and F_{dist}={F_{dist}^{(s)}; s=1, . . . , S}. f is the deep feature-based FR-IQA algorithm.

### C. Objective Function

The objective function is composed of three loss functions, namely the quality regression loss, the disturbance maximization loss and the content loss, denoted by [symbol] , [symbol] and [symbol] , respectively. In particular, the disturbance maximization loss focuses on maximizing the difference between \hat{F}_{ref}⁽¹⁾ and F_{ref}⁽¹⁾ such that the learned equal-quality space can contain as many equal-quality features as possible. The disturbance maximization loss is described as follows,

$${ℒ}_{dmax} = \frac{1}{{T}^{( 1 )} + ϵ} , \qquad ( 17 )$$

where ϵ is a small positive constant to avoid numerical instability when the denominator is close to zero. In this embodiment, ϵ is set to 1×10⁻⁶. Content loss is also utilized to make sure the primary content represented by \hat{F}_{ref} is the same as that of F_{ref} in the same scene. The content loss is represented as follows,

$${ℒ}_{ctt} = {\sum }_{l ∈ \{ {l}_{c} \}} MSE ( {\hat{F}}_{ref}^{( l )} , {F}_{ref}^{( l )} ) , \qquad ( 18 )$$

where l_{c} denotes the set of VGG16 layers for computing the content loss. In this embodiment, l_{c}={conv4_2}.

To keep the pseudo-reference features quality-aware, the quality regression loss is employed to minimize the mean-square error between the ground-truth quality score and the predicted quality score:

$${ℒ}_{pred} = MSE ( Q , Y ) , \qquad ( 19 )$$

where Y is the ground-truth quality score of I_{dist}. The objective function is defined as follows,

$$ℒ = {ℒ}_{pred} + {λ}_{1} {ℒ}_{dmax} + {λ}_{2} {ℒ}_{ctt} , \qquad ( 20 )$$

where λ₁ and λ₂ are the weighting factors of [symbol] and [symbol] , respectively.

In the next section, the implementation details of the FLRE in FIG. 1 is provided first. Then, the FLRE is compared with some existing FR-IQA models with respect to quality prediction on traditional and algorithm-dependent distortions. Finally, a series of ablation studies will be conducted about the contribution of each component in the FLRE and the impact of pseudo-reference features at different layers.

### A. Experimental Setup

The FLRE is trained on the entire KADID-10k dataset [73] and test on three traditional IQA datasets (LIVE [74], CSIQ [76] and TID2013 [75]) and three image restoration datasets with human-annotated scores (QADS [77], SHQR [78] and PIPAL [79]). More details are provided in Table I below.

TABLE I
DESCRIPTIONS OF THE IQA DATABASES

| | # of Ref. | | # of Dist. | # of |
|---|---|---|---|---|
| Dataset | Images | Dist. Types | Types | Images |
| KADID-10k [73] | 81 | traditional | 25 | 10,125 |
| LIVE [74] | 29 | traditional | 5 | 982 |
| TID2013 [75] | 25 | traditional | 24 | 3,000 |
| CSIQ [76] | 30 | traditional | 6 | 866 |
| QADS [77] | 20 | trad. & alg. outputs | 21 | 980 |
| SHRQ [78] | 75 | alg. outputs | 8 | 600 |
| PIPAL [79] | 250 | trad. & alg. outputs | 40 | 29,000 |

The FLRE is implemented by PyTorch [85]. The Adam [86] optimizer is utilized with an initial learning rate of 1×10⁻⁴ and a weight decay of 5×10⁻⁴. The learning rate is reduced by a factor of 5 after every 5 epochs. The FLRE is trained with 50 epochs for convergence on the KADID-10k dataset, and the batch size is set by 12. In Eqn. (16), the existing deep feature-based methods can be used as f for distance measurement. In this experiment DISTS [44], LPIPS [43] and DeepWSD [45] are deployed, where DISTS and DeepWSD are the pre-trained models on the KADID-10k dataset. For LPIPS, it is retrained on the KADID-10k dataset for fair comparison. The input size is 256×256×3. During the training of the FLRE, the parameters of the selected FR-IQA method are fixed. When f is LPIPS, the weighting parameters λ₁ and λ₂ in Eqn. (20) are set to 2 and 15, respectively. When f is set to DISTS trained on the KADID-10k dataset, the weighting parameters λ₁ and λ₂ in Eqn. (20) are set to 1 and 10, respectively. When f is set to DeepWSD trained on the KADID-10k dataset, the weighting parameters λ₁ and λ₂ in Eqn. (20) are set to 5 and 10, respectively.

With regards to the evaluation criteria, three common criteria, i.e., Spearman Rank Correlation Coefficient (SRCC), Pearson Linear Correlation Coefficient (PLCC) and Kendall rank-order correlation coefficient (KRCC), where SRCC and KRCC measure prediction monotonicity and PLCC reflects the prediction precision. The higher values of PLCC, KRCC and SRCC indicate the IQA model is more consistent with the HVS perception. A nonlinear logistic mapping function tis leveraged to evaluate the performance of various IQA methods on a common space before computing those correlation coefficients. The mapped score Q of the predicted score Q from the FR-IQA method can be computed as

$$\tilde{Q} = {ξ}_{1} ( \frac{1}{2} - \frac{1}{{e}^{{ξ}_{2} ( Q - {ξ}_{3} )}} ) + {ξ}_{4} Q + {ξ}_{5} , \qquad ( 21 )$$

where ξ1, ξ2, ξ3, ξ4 and ξ5 are to be determined during the curve fitting process.

### B. Performance on Quality Prediction

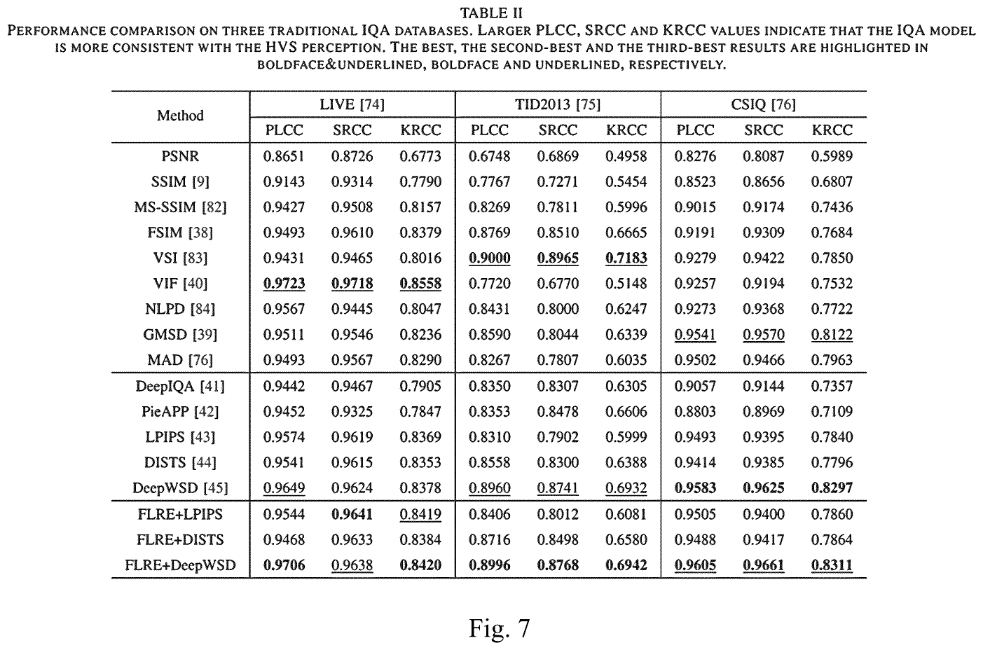

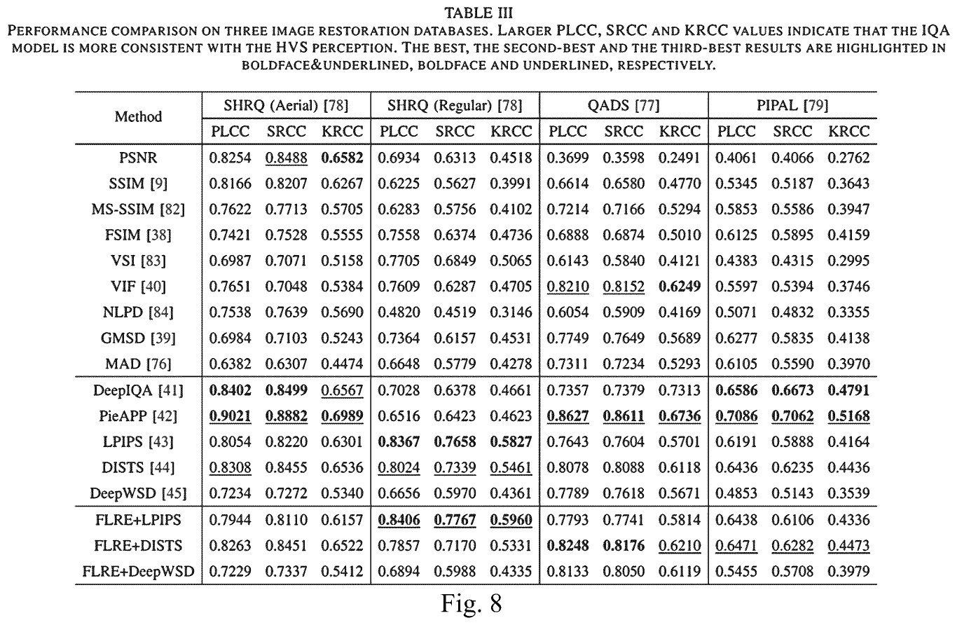

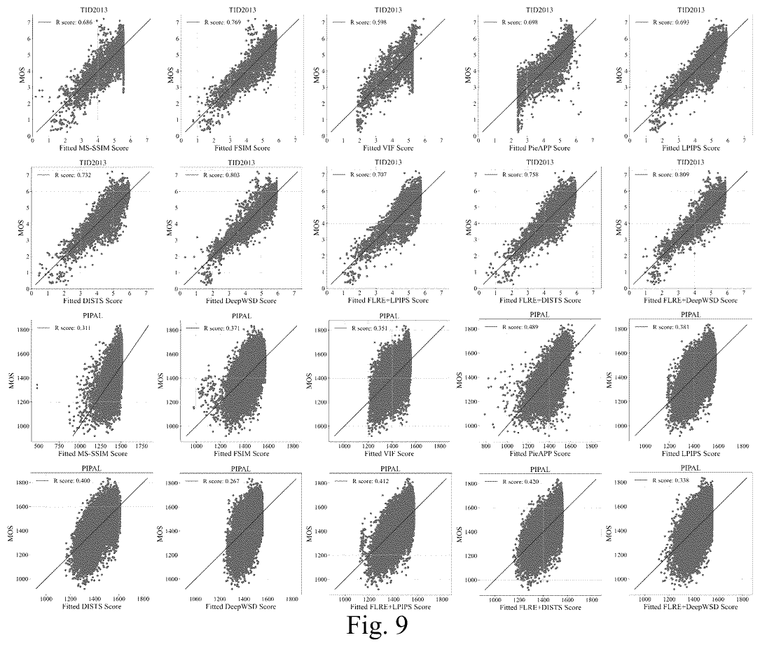

1) Correlation: In this experiment, the aim is to explore the consistency of the proposed model with the HVS in quality prediction. Several conventional FR-IQA models, including PNSR, SSIM [9], MS-SSIM [82], FSIM [38], VSI [83], VIF [40], NLPD [84], GMSD [39], MAD [76], DeepIQA [41], PieAPP [42], LPIPS [43], DISTS [44] and DeepWSD [45], are employed for performance comparison. To ensure a fair comparison, all the source codes of the competing models from the respective authors were obtained, except for DeepIQA and LPIPS. DeepIQA and LPIPS used in this experiment are their corresponding retrained version on the KADID-10k dataset. The comparison results are shown in Table II as shown in FIG. 7, and Table III as shown in FIG. 8, where FLRE+LPIPS, FLRE+DISTS and FLRE+DeepWSD represent LPIPS, DISTS and DeepWSD using pseudo-reference features predicted by FLRE, respectively. In FIGS. 7-8, larger PLCC, SRCC and KRCC values indicate that the IQA model is more consistent with the HVS perception. The best, the second-best and the third-best results are highlighted in boldface & underlined, boldface and underlined, respectively.

From the experimental results, one can see that compared with the conventional models, the embodiment of the invention combining FLRE with the existing deep feature-based methods can achieve competitive results on LIVE, TID2013, CSIQ, QADS, PIPAL. Furthermore, it can be found that the FLRE can improve the performance of the original of the original FR-IQA methods. In terms of SRCC, FLRE+LPIPS achieves around 0.23%, 1.39%, 0.05%, 1.80% and 3.70% improvements over LPIPS on LIVE, TID2013, CSIQ, QADS, PIPAL. FLRE+DISTS achieves around 0.19%, 2.39%, 0.34%, 1.09% and 0.75% improvements over DISTS on LIVE, TID2013, CSIQ, QADS, PIPAL. FLRE+DeepWSD achieves around 0.15%, 0.31%, 0.37%, 5.67% and 10.99% improvements over DeepWSD on LIVE, TID2013, CSIQ, QADS, PIPAL. It is worth noting that although FLRE+LPIPS and FLRE+DISTS have lower PLCC values on the LIVE database compared with LPIPS and DISTS, they still perform well in correctly ranking the relative image quality. For the SHRQ dataset, one can observe that the performance of the FLRE exhibits a slight decrease.

The GAN-based algorithms show remarkable visual performance in the image restoration field but pose significant challenges for IQA. Unlike synthetic distortions, the distortion introduced by GAN-based algorithms is more complicated to simulate. In Table IV below, the performance evaluation results of different FR-IQA models are provided with respect to GAN-based distortion on the PIPAL dataset. The experimental results show that LPIPS, DISTS and DeepWSD combined with the FLRE can further improve the prediction performance on GAN-generated IQA, even though they are not re-trained on any images generated by image restoration algorithms. In conclusion, the results in Table II and Table IV reveal the effectiveness of the FLRE, which is attributed to the capability of FLRE to flexibly select the reference feature of the distorted feature among numerous equal-quality features, thereby providing more accurate reference benchmark for FR-IQA than the given pristine-quality feature.

TABLE IV
SRCC RESULTS OF GAN-BASED DISTORTION
ON THE PIPAL DATASET. THE BEST TWO
RESULTS ARE HIGHLIGHTED IN BOLDFACE.

| | PIPAL (GAN-based distortion) | | |
|---|---|---|---|
| Method | PLCC | SRCC | KRCC |
| PSNR | 0.4096 | 0.2911 | 0.1985 |
| SSIM [9] | 0.5093 | 0.3394 | 0.2302 |
| MS-SSIM [82] | 0.6026 | 0.3887 | 0.2678 |
| FSIM [38] | 0.5631 | 0.4099 | 0.2818 |
| VSI [83] | 0.5310 | 0.3740 | 0.2554 |
| VIF [40] | 0.6033 | 0.3934 | 0.2724 |
| NLPD [84] | 0.5296 | 0.3389 | 0.2338 |
| GMSD [39] | 0.6093 | 0.4217 | 0.2917 |
| MAD [76] | 0.6876 | 0.3487 | 0.2384 |
| DeepIQA [41] | 0.5354 | 0.5443 | 0.3713 |
| PieAPP [42] | 0.5688 | 0.5540 | 0.3883 |
| LPIPS [43] | 0.5947 | 0.4297 | 0.2979 |
| DISTS [44] | 0.6132 | 0.5502 | 0.3826 |
| DeepWSD [45] | 0.4868 | 0.3584 | 0.2453 |
| FLRE + LPIPS | 0.6070 | 0.4689 | 0.3262 |
| FLRE + DISTS | 0.6498 | 0.5518 | 0.3855 |
| FLRE + DeepWSD | 0.4745 | 0.4102 | 0.2832 |

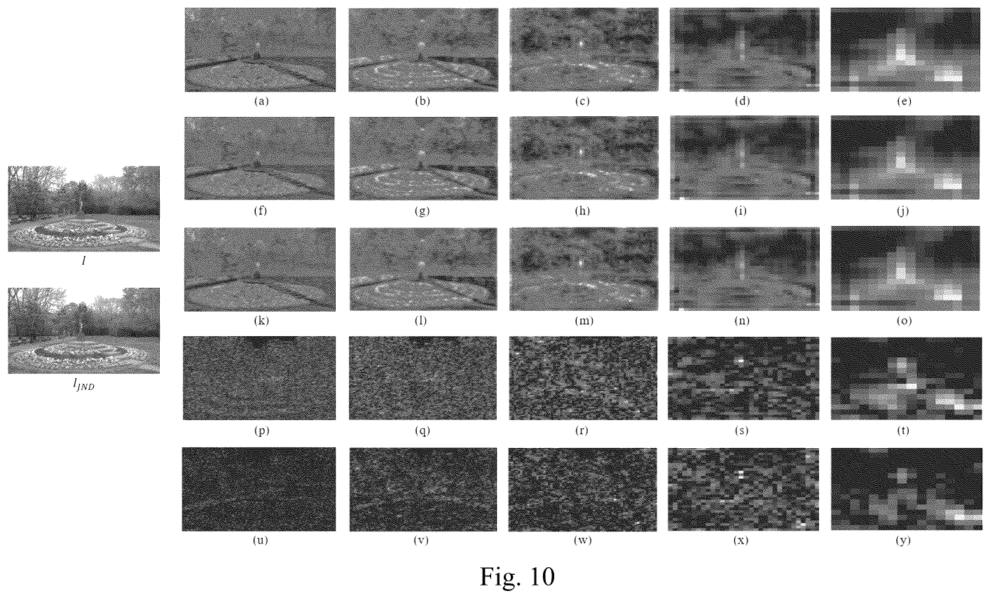

Scatter Plots: To further visualize the performance yielded by the competing FR-IQA models, the scatter plots of the subjective scores against the objective scores predicted by some representative IQA models on TID2013 and PIPAL datasets are in FIG. 9. In FIG. 9, the x-axis is the fitted score Q after mapping the raw objective score \tilde{Q} generated from each FR-IQA model via Eqn. (21), and the y-axis is the subjective score Y. R score reflects the goodness of fit. A larger R score means a stronger relationship between the subjective scores and the predicted scores. In each subplot, the closer the fitted scores gather around the red line, the closer the predicted results of the FR-IQA model are to human perceptual judgments. Herein, the goodness of fit R is adopted to quantify the relationship between Y and \tilde{Q}. The goodness of fit R can be described as:

$$R = \frac{{\sum }_{k = 1}^{K} {( {\tilde{Q}}_{k} - \overline{Y} )}^{2}}{{\sum }_{k = 1}^{K} {( {Y}_{k} - \overline{Y} )}^{2}} , \qquad ( 22 )$$

where K is the total number of distorted images in the dataset. \tilde{Q}ₖ and Yₖ are the fitted objective score and the subjective score of k-th distorted image, respectively. Y̅ is the average of the subjective scores of all distorted images in the dataset. From the results in FIG. 10, one can find that FR-IQA models with FLRE improve the goodness of fit of those original models without FLRE on TID2013 dataset and PIPAL dataset.

### C. Performance on Pseudo-Reference Generation

To demonstrate the accuracy of the reference predicted by the IQA method in FIG. 1, the method is tested on two JND datasets, i.e., VVC_JND dataset [55], MCL_JCL dataset [23]. VVC_JND dataset contains 202 pristine-quality images and their JND versions generated by the video coding reference platform of VVC [88]. MCL_JCL dataset consists of 50 pristine-quality images and their corresponding 50 JND images with JPEG compression distortion. When a distorted image is a JND image (i.e., the distorted image is in the equal-quality space), the reference of the distorted image is itself. In this experiment, the MSE value between the JND feature and the reference feature used by the FR-IQA model is computed for quality assessment. Ideally, the reference feature shall be as close as possible to the JND feature. Therefore, the smaller the MSE value, the better. Table V below reports the results in terms of average MSE (denoted as M̅S̅E̅) in the whole database.

TABLE V
COMPARISONS OF AVERAGE MSE BETWEEN THE
GROUND-TRUTH JND FEATURES AND THE REFERENCE
FEATURES USED BY DIFFERENT FR-IQA MODELS
FOR QUALITY ASSESSMENT.

| | VCC_JND | | | | | |
|---|---|---|---|---|---|---|
| | | | | FLRE + | FLRE + | FLRE + |
| Method | LPIPS | DISTS | DeepWSD | LPIPS | DISTS | DeepWSD |
| M̅S̅E̅ | 0.2139 | 0.2020 | 0.0083 | 0.0953 | 0.0598 | 0.0010 |
| | MCL_JCL | | | | | |
| | | | | FLRE + | FLRE + | FLRE + |
| Method | LPIPS | DISTS | DeepWSD | LPIPS | DISTS | DeepWSD |
| M̅S̅E̅ | 0.2048 | 0.2285 | 0.0066 | 0.0909 | 0.0774 | 0.0008 |

Compared with the original FR-IQA models, one can find that the MSE values of FLRE+LIPIS, FLRE+DISTS and FLRE+DeepWSD decrease by 55.45%, 70.40%, 87.95%, respectively, on the VVC_JND dataset, and by 55.62%, 66.13%, 87.88%, respectively, on MCL_JCL dataset. Those results demonstrate that the pseudo-reference features predicted by the FLRE can better explain the distorted features compared to the given pristine-quality features.

In FIG. 10, there is provided an explicate comparison by visualizing the given reference features used by LPIPS and the pseudo-reference features used by FLRE+LPIPS. In FIG. 10, I is the given pristine-quality image, I_{JND} is its JND version for JPEG compression distortion. Sub-images (a)-(e) in FIG. 10 are the feature maps of I at different scales. Sub-images (f)-(e) in FIG. 10 are the feature maps of I_{JND} at different scales. Sub-images (k)-(o) in FIG. 10 are the predicted pseudo-reference feature maps. Sub-images (p)-(t) in FIG. 10 are the difference maps between the features maps of I and I_{JND}. Sub-images (u)-(y) in FIG. 10 are the difference maps between the predicted pseudo-reference feature maps and the features maps of I_{JND}.

It is worth noting that for the feature at each scale, the channel dimension is reduced by taking the average pooling operation along its channel axis for better visualization. One can observe that the pseudo-reference features generated by the IQA method are closer to the JND features. Furthermore, comparing sub-images (p) and (u) in FIG. 11, one can find that the FLRE reduces the impact of distortion that occurs in complex textured areas (e.g., grass and leaves), which is consistent with the perception of the HVS. The HVS is highly adapted to extract highly complex repeated regions.

### D. Ablation Studies

To investigate the contributions of different modules and loss functions in the FLRE, ablation experiments are conducted based on FLRE+DeepWSD as an example. The corresponding results are listed in Table VI below, where experiments 1 and 6 are DeepWSD and FLRE+DeepWSD. In particular, the PRS from FLRE+DeepWSD is ablated and only use [symbol] to optimize the learnable feature space of the PNTE module in the second experiment. When evaluating the quality of the distorted image, the second variant directly uses the output of the PNTE module to perform IQA without the PSR. The SRCC results in the second experiment demonstrate that the performance of the second variant significantly decreases on all five datasets, revealing that the effectiveness of the FLRE is not attributed to the increased number of convolutional layers. Furthermore, by comparing the results of the second and fourth experiments, one can find that the model using the PRS gains higher performance, which demonstrates the PRS can effectively select the pseudo-reference feature for IQA. To verify the effectiveness of the PNTE module, the PNTE module is replaced with two 3×3 convolutions with the stride of 1, resulting in the third experimental setting. The SRCC results show that the PNTE module can better learn the equal-quality feature with the guidance of the spatial correlation feature. By comparing the SRCC results of the fourth and fifth variants, one can observe that the learned equal-quality space optimized by [symbol] leads to better performance on image restoration databases containing GAN-based and CNN-based distorted images. Then, [symbol] is further added to enforce the consistency of primary content between the images in the learned equal-quality space and the given pristine-quality image. The results indicate that the IQA method obtains a higher SRCC value when simultaneously using [symbol] , [symbol] and [symbol] .

TABLE VI
ABLATION STUDIES ON NETWORK ARCHITECTURES AND LOSS FUNCTIONS OF
FLRE + DEEPWSD. THE BEST TWO RESULTS ARE HIGHLIGHTED IN BOLDFACE

| Exp. ID | PNTE | PRS | [symbol] _{pred} | [symbol] _{dmax} | [symbol] _{ctt} | LIVE | TID2013 | CSIQ | QADS | PIPAL | Average |
|---|---|---|---|---|---|---|---|---|---|---|---|
| 1 | x | x | x | x | x | 0.9624 | 0.8741 | 0.9625 | 0.7618 | 0.5143 | 0.8150 |
| 2 | ✓ | x | ✓ | x | x | 0.8155 | 0.7836 | 0.8518 | 0.6452 | 0.4659 | 0.7124 |
| 3 | x | ✓ | ✓ | x | x | 0.9148 | 0.8852 | 0.9463 | 0.7445 | 0.5125 | 0.8007 |
| 4 | ✓ | ✓ | ✓ | x | x | 0.9634 | 0.8734 | 0.9638 | 0.7854 | 0.5294 | 0.8231 |
| 5 | ✓ | ✓ | ✓ | ✓ | x | 0.9626 | 0.8694 | 0.9669 | 0.7753 | 0.5432 | 0.8235 |
| 6 | ✓ | ✓ | ✓ | ✓ | ✓ | 0.9638 | 0.8768 | 0.9661 | 0.8050 | 0.5708 | 0.8371 |

In addition, FLRE+DeepWSD is compared with its eight variants using pseudo-reference features from different layers: (1)-(5) using the pseudo-reference feature from an individual layer; (6)-(8) using pseudo-reference features from multiple layers. In particular, when using the pseudo-reference feature from an individual layer, the model only performs the PNTE module and the PRS at the specific layer. When using pseudo-reference features from multiple layers, firstly the near-threshold map based on F_{ref}⁽¹⁾ is predicted and fed into VGG16 to construct the equal-quality space at each layer. Subsequently, the PRS is used to locate the reference feature of the distorted feature at each layer. Finally, the reference features at different layers are obtained for IQA. The SRCC comparison results on five datasets are reported in Table VII below. One can find that the IQA model achieves the best performance when the given pristine-quality feature at each layer is replaced by its corresponding pseudo-reference features. This phenomenon demonstrates that the features of different layers jointly govern the image quality. When the given pristine-quality features are replaced by the predicted pseudo-reference features that better explain the distorted image, the FR-IQA model can make a more accurate prediction.

TABLE VII
PERFORMANCE COMPARISON OF FLRE + DEEPWSD USING PSEUDO-REFERENCE
FEATURE AT DIFFERENT LAYERS. THE BEST TWO RESULTS ARE HIGHLIGHTED
IN BOLDFACE. THE DEFAULT SETTING OF FLRE + DEEPWSD IS HIGHLIGHTED.

| No. | Reference Feature | LIVE | TID2013 | CSIQ | QADS | PIPAL | Average |
|---|---|---|---|---|---|---|---|
| 1 | {F′_{ref}⁽¹⁾, F_{ref}⁽²⁾, F_{ref}⁽³⁾, F_{ref}⁽⁴⁾, F_{ref}⁽⁵⁾} | 0.9633 | 0.8774 | 0.9641 | 0.7924 | 0.5532 | 0.8331 |
| 2 | {F_{ref}⁽¹⁾, F′_{ref}⁽²⁾, F_{ref}⁽³⁾, F_{ref}⁽⁴⁾, F_{ref}⁽⁵⁾} | 0.9629 | 0.8748 | 0.9645 | 0.7702 | 0.5162 | 0.8177 |
| 3 | {F_{ref}⁽¹⁾, F_{ref}⁽²⁾, F′_{ref}⁽³⁾, F_{ref}⁽⁴⁾, F_{ref}⁽⁵⁾} | 0.9620 | 0.8721 | 0.9626 | 0.7577 | 0.5036 | 0.8116 |
| 4 | {F_{ref}⁽¹⁾, F_{ref}⁽²⁾, F_{ref}⁽³⁾, F′_{ref}⁽⁴⁾, F_{ref}⁽⁵⁾} | 0.9624 | 0.8737 | 0.9625 | 0.7609 | 0.5135 | 0.8146 |
| 5 | {F_{ref}⁽¹⁾, F_{ref}⁽²⁾, F_{ref}⁽³⁾, F_{ref}⁽⁴⁾, F′_{ref}⁽⁵⁾} | 0.9624 | 0.8739 | 0.9625 | 0.7613 | 0.5141 | 0.8148 |
| 6 | {F′_{ref}⁽¹⁾, F′_{ref}⁽²⁾, F_{ref}⁽³⁾, F_{ref}⁽⁴⁾, F_{ref}⁽⁵⁾} | 0.9628 | 0.8788 | 0.9660 | 0.7937 | 0.5471 | 0.8297 |
| 7 | {F′_{ref}⁽¹⁾, F′_{ref}⁽²⁾, F′_{ref}⁽³⁾, F_{ref}⁽⁴⁾, F_{ref}⁽⁵⁾} | 0.9621 | 0.8733 | 0.9669 | 0.7783 | 0.5411 | 0.8243 |
| 8 | {F′_{ref}⁽¹⁾, F′_{ref}⁽²⁾, F′_{ref}⁽³⁾, F′_{ref}⁽⁴⁾, F_{ref}⁽⁵⁾} | 0.9627 | 0.8749 | 0.9657 | 0.7958 | 0.5683 | 0.8335 |
| 9 | {F′_{ref}⁽¹⁾, F′_{ref}⁽²⁾, F′_{ref}⁽³⁾, F′_{ref}⁽⁴⁾, F′_{ref}⁽⁵⁾} | 0.9638 | 0.8768 | 0.9661 | 0.8050 | 0.5708 | 0.8365 |

In summary, as one can see, in the above exemplary embodiment, a new FR-IQA paradigm which is the FLRE is proposed. The paradigm/method starts by producing the equal-quality space given the pristine-quality image by identifying the near-threshold distortion. Subsequently, rooted in the widely accepted view that the intrinsic and perceptually-meaningful features govern the image quality, the feature-level pseudo-reference of the distorted image is constructed. The main characteristic of the embodiment can be summarized as follows.
A new FR-IQA paradigm FLRE is proposed, which is developed at the feature level, enabling that distorted image to flexibly choose its best reference within the equal-quality space.
a PNTE module is devised, constructing the equal-quality space of the given pristine-quality image at the feature level.
A pseudo-Reference Search (PRS) strategy is developed with an element-wise minimum distance search manner. The underlying principle behind the strategy is that the reference feature of the distorted feature should be the feature that best explains the distorted feature within the equal-quality space.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

The functional units and modules of the systems and methods in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, WAN, LAN, the Internet, and other forms of data transmission medium.

What is claimed is:

1. An image quality assessment (IQA) method, comprising the steps of:
a) providing a pristine image, and a distorted image related to the pristine image;
b) constructing an equal-quality space of the pristine image at feature level;
c) finding, within the equal-quality space, a best reference of a distorted feature of the distorted image; and
d) constructing a pseudo-reference feature of the distorted feature.

2. The IQA method of claim 1, wherein Step b) further comprises:
e) estimating a near-threshold map of a feature extracted from the pristine image; and
f) constructing the equal-quality space under a guidance of the near-threshold map.

3. The IQA method of claim 2, wherein Step e) further comprises:
g) predicting the near-threshold map based on a global spatial correlation map and a local spatial correlation map.

4. The IQA method of claim 3, further comprising, before Step g), steps of:
h) calculating a global standard deviation of the feature extracted from the pristine image;
i) calculating a local standard deviation of the feature extracted from the pristine image; and
j) generating the global and local spatial correlation maps based on the global and local standard deviations.

5. The IQA method of claim 1, wherein Step c) further comprises locating the best reference of the distorted feature within the equal-quality space in an element-wise minimum distance search manner.

6. The IQA method of claim 1, further comprising a step of optimizing the constructed equal-quality space using at least one of a quality regression loss, a disturbance maximization loss and a content loss.

7. The IQA method of claim 5, wherein the step of optimizing the constructed equal-quality space uses all of the quality regression loss, the disturbance maximization loss and the content loss.

8. The IQA method of claim 1, wherein in Step b) the equal-quality space is constructed using a pre-trained artificial neural network.

9. The IQA method of claim 8, wherein Step c) is performed at every layer of the artificial neural network.

10. The IQA method of claim 1, further comprising a step of predicting a quality score based on the distorted feature and the pseudo-reference feature.

11. A non-transitory computer-readable memory recording medium having computer instructions recorded thereon, the computer instructions, when executed on one or more processors, causing the one or more processors to perform operations according to the method according to claim 1.

12. A computing system comprising:
a) one or more processors; and
b) memory containing instructions that, when executed by the one or more processors, cause the computing system to perform operations according to the method of claim 1.
